(19) United States
(12) Patent Application Publication
(10) Pub. No.: US 2022/0366514 A1
(43) Pub. Date: Nov. 17, 2022

(54) Method and Apparatus for Agricultural Management

(71) Applicant: Telefonaktiebolaget LM Ericsson (publ), Stockholm (SE)

(72) Inventor: Ning Zhang, Beijing (CN)

(21) Appl. No.: 17/774,367

(22) PCT Filed: Jan. 20, 2020
(86) PCT No.: PCT/CN2020/073249

§ 371 Date: May 4, 2022

(51) Int. Cl. G06Q 50/02; G06Q 10/06

(52) U.S. Cl. CPC G06Q 50/02; G06Q 10/06315; G06Q 10/0635

(57) ABSTRACT

Embodiments of the present disclosure provide methods and apparatuses for agricultural management. A method performed by a communication device comprises obtaining agriculture relevant information in a geographic area including a plurality of agricultural product production areas. The method further comprises generating agricultural activity suggestion for at least one of the plurality of agricultural product production areas based on the agriculture relevant information. The method further comprises sending the agricultural activity suggestion to the at least one of the plurality of agricultural product production areas.

### TECHNICAL FIELD

The non-limiting and exemplary embodiments of the present disclosure generally relate to the technical field of communications, and specifically to methods and apparatuses for agricultural management.

### BACKGROUND

This section introduces aspects that may facilitate a better understanding of the disclosure. Accordingly, the statements of this section are to be read in this light and are not to be understood as admissions about what is in the prior art or what is not in the prior art.

There are various agricultural management systems such as farm management system, agricultural land management system, agricultural environmental management system, agricultural resource management system, etc. For example, the farm management system may provide some features such as accounting, CRM (customer relationship management), contract management, crop/livestock management, inventory management, labor management, order processing, pricing management, supplier management, etc.

An agricultural production procedure may include multiple steps such as agricultural product selection, cultivation, logistics, warehouse, etc. In each step, there may be many specialists to guide the corresponding people like farmers in rural area, logistical firms that have business among agricultural product production areas such as farms and agricultural product consumption areas such as supermarkets in downtowns. The agricultural activities in each step may be managed, observed and supported by stakeholders. For example, before cropping commences, the farmer has to make decisions which may affect the subsequent operational management. The farmer has to choose the crop and the operational requirements generally follow from this. Such operational requirements at farm level may include: water management in relation to crop moisture requirements, tillage and land preparation, liming or acidity control, fertilizer use, crop protection, etc.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The existing agricultural management systems may have some problems. For example, as described above, the agricultural activities in each step of the agricultural production procedure may be managed, observed and supported by stakeholders, however these stakeholders may work for different departments such as governments, organizations, association, etc. In this way, some steps of the agricultural production procedure may be inflected or even manipulated by humans who don't have the overall picture of the agricultural production procedure, therefore there may be communication overhead or asymmetric information, which may finally result in problems.

There may be much waste and/or low efficiency in the agricultural production procedure. For example, some farmers may hardly change their mind when selecting agricultural production before the cultivation, which may result in waste if their agricultural products are not popular in the market. Some farmers may not have experienced knowledge to fight with disaster such as pest and/or extreme weathers. Some farmers may not have experienced knowledge for precision cultivation. Even if the farmers are aware to change, the agriculture relevant information such as information among the market is asymmetric to them. The nearby farms may have limited chances to share all kinds of information.

The logistical fee is relatively high for some farms as they are located remotely. Even though there is highway or expressway nearby. The logistical firms are not likely to establish business with them as the commercial benefit may be considerably low.

Some governments launch big foundations to improve or optimize the agricultural production procedure, but somehow there are still many wastes in agriculture according to the statistical data.

Some consumers may complain they are hard to purchase their favorite agricultural products in supermarkets or the price is too high. Even though they can purchase online directly from the farm, as they cannot check the agricultural products in person, sometimes the quality of the agricultural products is rather bad. Considering the logistical time cost, the user experience is not so good. Also the online ordering may have a requirement of minimum of quantity that is not convenience to small families.

To overcome or mitigate at least one of the above mentioned problems or other problems, embodiments of the present disclosure propose an improved agricultural management solution.

In an embodiment, the proposed agricultural management solution may guide the owner(s) (such as farmer(s)) of the agricultural product production area to do better and accurate agriculture activities in an iterative way based on agriculture relevant information.

In an embodiment, the proposed agricultural management solution may share agriculture relevant information among the agricultural product production areas nearby and then provide an optimized centralized agricultural management.

In an embodiment, the agriculture relevant information may comprise the comparison and analysis (assisted with human experts when needed) of agricultural productions, weather data, arable lands status, and warehouse conditions and availabilities.

In an embodiment, the proposed agricultural management solution may observe inflows to target agricultural product consumption areas (such as cities) and get the most expected agricultural product in the target agricultural product consumption areas.

In an embodiment, the proposed agricultural management solution may observe the logistical data around the owned and nearby agricultural product production areas to enhance the above analyzed data and get more accurate forecast for the cultivation in the coming season.

In an embodiment, the proposed agricultural management solution may collect the most favorite dishes, snacks, fruits, etc. of the consumers for the reference of the agricultural product production areas.

In an embodiment, based on the agriculture relevant information, the proposed agricultural management solution may provide suggestion and/or recommendation for agricultural product production areas such as farms in a geographic area with optimized proposals. As years go by, the proposed agricultural management solution may learn more on the agricultural knowledge in this geographic area and collect more accurate data in the target agricultural product consumption areas. The proposed agricultural management solution may also encourage the agricultural product production areas such as farms to collect feedback from consumers in a more economical and efficient way that will be a win-win deal.

In a first aspect of the disclosure, there is provided a method performed by a communication device. The method comprises obtaining agriculture relevant information in a geographic area including a plurality of agricultural product production areas. The method further comprises generating agricultural activity suggestion for at least one of the plurality of agricultural product production areas based on the agriculture relevant information. The method further comprises sending the agricultural activity suggestion to the at least one of the plurality of agricultural product production areas.

In an embodiment, the agriculture relevant information may include at least one of soil data of an agricultural product production area, climate data of an agricultural product production area, agricultural production materials data, disaster data of an agricultural product production area, statistical data of agricultural product consumption in an agricultural product consumption area, trend analysis of agricultural product consumption in an agricultural product consumption area, warehouse condition and availability, and logistical data related to agricultural product.

In an embodiment, the logistical data related to agricultural product may be obtained from at least one of an electronic device installed on a logistical vehicle, an electronic device installed at a road entrance and exit of an agricultural product consumption area, and an electronic device installed along a road.

In an embodiment, the logistical data related to agricultural product may include at least one of an identity of agricultural product, a weight of agricultural product, an original place of agricultural product, a destination of agricultural product, and information of a warehouse in which the agricultural product has been stored.

In an embodiment, the agricultural activity suggestion may include risk mitigation suggestion for a first agricultural product production area and the generating step may comprise determining a risk factor of disaster for the first agricultural product production area; and generating the risk mitigation suggestion for the first agricultural product production area based at least partly on the risk factor of disaster.

In an embodiment, the risk mitigation suggestion for the first agricultural product production area may comprise suggestion for a cooperating agricultural product production area and/or a warehouse.

In an embodiment, the cooperating agricultural product production area may have similar environment with the first agricultural product production area and have a free land to lend. The warehouse can store agriculture materials of the first agricultural product production area.

In an embodiment, the cooperating agricultural product production area and/or the warehouse may be on a routine between the first agricultural product production area and a target agricultural product consumption area. As used herein, the term “routine” is synonymous with “route” or “routing”, as will be apparent from each context in which the term is used.

In an embodiment, the cooperating agricultural product production area and/or the warehouse may be on a routine between the first agricultural product production area and a target agricultural product consumption area.

In an embodiment, the agricultural activity suggestion may include new markets development suggestion for a second agricultural product production area and the generating step may comprise identifying one or more agricultural product consumption areas within a predefined distance from the second agricultural product production area, wherein the one or more agricultural product consumption areas are not supplied by any agricultural product production area within the predefined distance; identifying at least one of the one or more agricultural product consumption areas with an agricultural product supplied by single agricultural product production area or a supply percentage of single agricultural product production area of an agricultural product is more than a predefined percentage; and generating new markets development suggestion for the second agricultural product production area based on the at least one of the one or more agricultural product consumption areas.

In an embodiment, the new markets development suggestion for the second agricultural product production area may comprise at least one of indicating the second agricultural product production area to select a potential target agricultural product consumption area on a routine between the second agricultural product production area and an existing agricultural product consumption area supplied by the second agricultural product production area; and indicating the second agricultural product production area to select a potential target agricultural product consumption area within a predefined distance in an extended line of an existing routine between the second agricultural product production area and an existing agricultural product consumption area supplied by the second agricultural product production area.

In an embodiment, the agricultural activity suggestion may include suggestion of agricultural production materials for a third agricultural product production area and the generating step may comprise determining a target logistical firm and a target source of the agricultural production materials for the third agricultural product production area based on logistical data related to agricultural product and agricultural production materials data; and generating the suggestion of agricultural production materials for the third agricultural product production area based on the determined target logistical firm and the target source of the agricultural production materials.

In an embodiment, the agricultural activity suggestion may include planting suggestion for a fourth agricultural product production area.

In an embodiment, the communication device may be a server or a terminal device.

In a second aspect of the disclosure, there is provided a method performed by a terminal device. The method comprises obtaining agricultural activity suggestion for an agricultural product production area from a server. The method further comprises providing the agricultural activity suggestion for the agricultural product production area to the agricultural product production area. The agricultural activity suggestion for the agricultural product production area is generated based on agriculture relevant information.

In a third aspect of the disclosure, there is provided a communication device. The communication device comprises a processor; and a memory coupled to the processor, said memory containing instructions executable by said processor, whereby said communication device is operative to obtain agriculture relevant information in a geographic area including a plurality of agricultural product production areas. Said communication device is further operative to generate agricultural activity suggestion for at least one of the plurality of agricultural product production areas based on the agriculture relevant information. Said communication device is further operative to send the agricultural activity suggestion to the at least one of the plurality of agricultural product production areas.

In a fourth aspect of the disclosure, there is provided a terminal device. The terminal device comprises a processor; and a memory coupled to the processor, said memory containing instructions executable by said processor, whereby said terminal device is operative to obtain agricultural activity suggestion for an agricultural product production area from a server. Said terminal device is further operative to provide the agricultural activity suggestion for the agricultural product production area to the agricultural product production area. The agricultural activity suggestion for the agricultural product production area is generated based on agriculture relevant information.

In a fifth aspect of the disclosure, there is provided a communication device. The communication device comprises an obtaining module, a generating module and a sending module. The obtaining module may be configured to obtain agriculture relevant information in a geographic area including a plurality of agricultural product production areas. The generating module may be configured to generate agricultural activity suggestion for at least one of the plurality of agricultural product production areas based on the agriculture relevant information. The sending module may be configured to send the agricultural activity suggestion to the at least one of the plurality of agricultural product production areas.

In a sixth aspect of the disclosure, there is provided a terminal device. The terminal device comprises an obtaining module and a providing module. The obtaining module may be configured to obtain agricultural activity suggestion for an agricultural product production area from a server. The agricultural activity suggestion for the agricultural product production area may be generated based on agriculture relevant information The providing module may be configured to provide the agricultural activity suggestion for the agricultural product production area to the agricultural product production area.

In a seventh aspect of the disclosure, there is provided a computer-readable storage medium storing instructions which when executed by at least one processor, cause the at least one processor to perform any step of the method according to the first aspect of the present disclosure.

In an eighth aspect of the disclosure, there is provided a computer-readable storage medium storing instructions which when executed by at least one processor, cause the at least one processor to perform any step of the method according to the second aspect of the present disclosure.

In a ninth aspect of the disclosure, there is provided a computer program product comprising instructions which when executed by at least one processor, cause the at least one processor to perform any step of the method according to the first aspect of the present disclosure.

In a tenth aspect of the disclosure, there is provided a computer program product comprising instructions which when executed by at least one processor, cause the at least one processor to perform any step of the method according to the second aspect of the present disclosure.

Embodiments herein afford many advantages, of which a non-exhaustive list of examples follows. Some embodiments herein can centralize all agricultural product production areas (such as farms) in a geographic area to optimize all kinds of information asymmetric and communication overhead, save cost for warehouse and logistic, reduce waste, and increase the satisfaction for consumers and the income for producers such as farmers. Some embodiments herein can self-organize all farms in an area to work more tightly with exchanging information and then optimize the cultivation. Some embodiments herein can connects the farm, warehouse, logistics firm, supermarket and the end consumers before the agricultural cultivation and reduce the relevant fees in each steps of the entire agricultural product production process and even the advertisement fee for products. Some embodiments herein can enable the farm to have a clear plan of what and how to calculate the agricultural products. Some embodiments herein can enable farms nearby to establish the backup mechanisms to conquer the disaster such as the pest diseases, destruction by extreme weathers, etc. Some embodiments herein can enable the warehouse to be more effectively utilized. Some embodiments herein can enable the logistics routine to be optimized (e.g., save leading time to downtown and energies by trucks). Some embodiments herein can enable the end consumer to enjoy a better shopping environment with more favorite products. For example, they can even visit the original farm to see how these products are cultivated, which is another way to increase the income for the farm. Some embodiments herein can enable the root cause to be easily found when any situation is happened. In some embodiments herein, the budget of the farm can be easily controlled while the income can be forecasted, which is a good way to plan for the farm. Some embodiments herein can improve the entire agricultural production line from the farm to the dining table and encourage the owner of farms to cooperative together in a more graceful way. In some embodiments herein, the proposed method may be suitable in a large area where farms are located in vast of lands as well as their target cities are always far away. In some embodiments herein, the proposed method may centralize the information in all relevant areas, such as land, climate, warehouse, logistics, favorite dishes (raw materials), waste recycling, etc. In this way, the overhead of all interconnecting steps and communication could be significantly reduced. In some embodiments herein, the proposed method may mitigate the risk for both farms and target cities, for example, any disaster would result in the great damage to farms and the inflation to target cities. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of a method according to an embodiment of the present disclosure;

FIG. 2 shows a flowchart of generating risk mitigation suggestion according to an embodiment of the present disclosure;

FIG. 3 shows a flowchart of risk identification of algorithm example of risk mitigation according to an embodiment of the present disclosure;

FIG. 4 shows a flowchart of backup mechanism of algorithm example of risk mitigation according to an embodiment of the present disclosure;

FIG. 5 shows a flowchart of generating new markets development suggestion according to an embodiment of the present disclosure;

FIG. 6 shows a flowchart of algorithm example of generating new markets development suggestion according to another embodiment of the present disclosure;

FIG. 7 shows a flowchart of generating the suggestion of agricultural production materials according to an embodiment of the present disclosure;

FIG. 8 shows a flowchart of a method according to another embodiment of the present disclosure;

FIG. 9 schematically shows a topology of farm and city according to an embodiment of the present disclosure;

FIG. 10 is a block diagram showing an apparatus suitable for practicing some embodiments of the disclosure;

FIG. 11 is a block diagram showing a communication device according to an embodiment of the disclosure; and

FIG. 12 is a block diagram showing a terminal device according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” or “communication network” refers to a network following any suitable (wireless or wired) communication standards. For example, the wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols. For example, the wireless communication protocols may comprise the first generation (1G), 2G, 3G, 4G, 4.5G, 5G communication protocols, and/or any other protocols either currently known or to be developed in the future.

As used herein, the term “communication device” refers to any electronic equipment that implement communication function. The communication device may operably communicate with terminal devices through the network. The communication device may provide services associated with the agricultural management or other services. For example, the communication device may obtain agriculture relevant information in a geographic area including a plurality of agricultural product production areas, generate agricultural activity suggestion for at least one of the plurality of agricultural product production areas based on the agriculture relevant information and send the agricultural activity suggestion to the at least one of the plurality of agricultural product production areas. The communication device can be implemented in form of hardware, software or their combination, including but not limited to, cloud computer, distributed communication system, virtual computer, server, terminal device, etc. The communication device may run with any kind of operating system including, but not limited to, Windows, Linux, UNIX, Android, iOS and their variants.

As used herein, the term “terminal device” refers to any end device that can access a communication network and receive services therefrom. By way of example and not limitation, in the wireless communication network, the terminal device may refer to a mobile terminal, a user equipment (UE), a terminal device, or other suitable devices. The terminal device may be, for example, a Subscriber Station (SS), a Portable Subscriber Station, a Mobile Station (MS), or an Access Terminal (AT). The terminal device may include, but not limited to, a portable computer, an image capture device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable device, a vehicle-mounted wireless device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a UE may represent a terminal device configured for communication in accordance with one or more communication standards promulgated by the 3GPP, such as LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a UE may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

As yet another example, in an Internet of Things (IoT) scenario, a terminal device may represent a machine or other device that can perform monitoring and/or measurements, and transmit the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

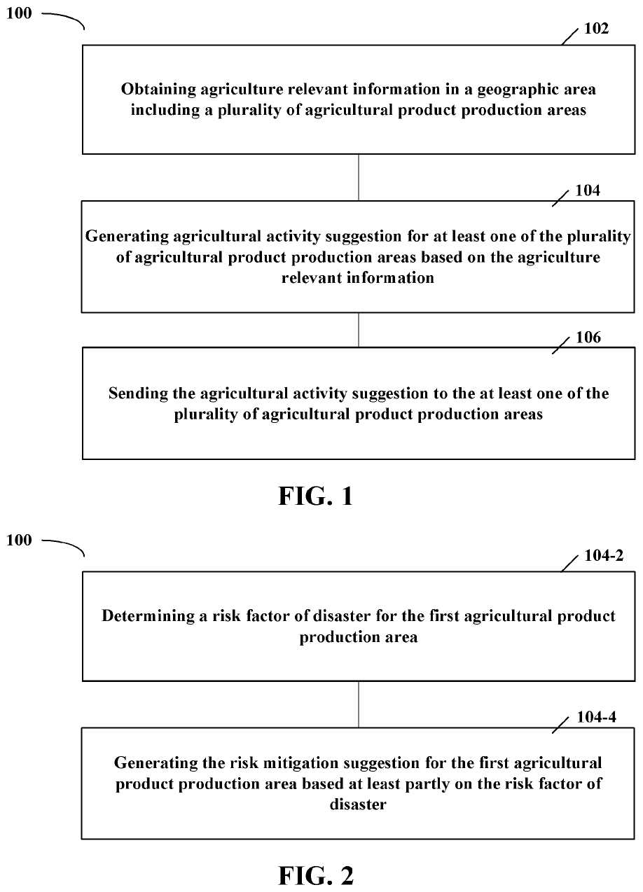

FIG. 1 shows a flowchart of a method 100 according to an embodiment of the present disclosure, which may be performed by an apparatus implemented in or as or communicatively coupled to a communication device (such as terminal device or server) or any other entity having similar functionality. As such, the communication device may provide means or modules for accomplishing various parts of the method 100 as well as means or modules for accomplishing other processes in conjunction with other components.

At block 102, the communication device may obtain agriculture relevant information in a geographic area including a plurality of agricultural product production areas. In an embodiment, the geographic area may further include at least one agricultural product consumption area. The geographic area may be of any suitable shape and size. The geographic area may be determined in various ways. For example, the geographic area may be determined based on maximum supply range or radius of one agricultural product production area or more nearby agricultural product production areas. For example, supposing the maximum supply range or radius of an agricultural product production area (such as farm) is R₀, then the geographic area may be a circle with the center of agricultural product production area as its center and R₀ as its radius. In addition, the geographic area may be determined or amended manually. The agricultural product production area may be of any suitable shape and size. For example, the agricultural product production area may include one farm or more nearby farms. The agricultural product consumption area may be of any suitable shape and size. For example, the agricultural product consumption area may include one or more nearby residential zones such as urban area, city town, county town, city, village, etc. The agriculture relevant information may include any suitable information related to the agriculture such as agricultural product consumption data, agricultural product production data, disaster data, arable lands status, warehouse conditions and availabilities, logistical data related to agricultural product, agricultural policy, statistical data of agricultural product production and consumption, etc.

In an embodiment, the agriculture relevant information may include at least one of soil data of an agricultural product production area, climate data of an agricultural product production area, agricultural production materials data, disaster data of an agricultural product production area, statistical data of agricultural product consumption in an agricultural product consumption area, trend analysis of agricultural product consumption in an agricultural product consumption area, warehouse condition and availability, and logistical data related to agricultural product. The disaster data may include data related to pest diseases and/or destruction by extreme weathers such as drought, flood, typhoon, etc. The soil data may include fertility, moisture, etc. The agricultural production materials may include any suitable materials that can be used in the agricultural production, for example, pesticides, chemical fertilizers, fuels, packaging materials, plants, seeds, animals for farming, agricultural wastes (such as agricultural waste that can be processed as fertilizer), farm tools, farm implements, etc. The agricultural production materials data may include the price, identifier, quantity, location, etc. of the agricultural production materials.

The communication device may obtain the agriculture relevant information in various ways. For example, the communication device may determine some agriculture relevant information by itself or obtain them from another information source.

In an embodiment, the statistical data and/or trend analysis of agricultural product consumption in an agricultural product consumption area can be obtained by using media content analysis from social networks. For example, most people may have at least one social network, they are willing to explore the website regarding all kinds of interests including favorite foods and famous restaurants in a dedicated area. Some people also likes to post their self-cooked dishes on Internet and always comment others. When the communication device obtains such data, it can easily conclude an analysis report that in this dedicated area, for example, there are totally N most popular dishes which may use M kinds of agricultural products. In addition, based on the historical data in previous years, it can also easily make a trend analysis based on the people's flavor change and/or agricultural product raw material changes. For example, a certain area has increasing people like cakes, which means there might be an increasing demand on butterfly, cheese, etc. People are becoming like some western style dishes, such as steak, coffee, etc. With the extra data showing that the consumers are high end consumers in luxury restaurants, it might mean that supplying beefs and coffee beans might be a beneficial idea in the coming seasons.

In an embodiment, the statistical data and trend analysis can be obtained from another information source such as consulting groups, websites, big data companies, etc. If these data (e.g., statistical data and trend analysis) can be shared among farms (under an agreement that protect the privacy), it would be great to farmers to select which agricultural product that they should cultivate (that could even more popular for target agricultural product consumption areas such as cities).

In an embodiment, any trend of agricultural product consumption may have interconnection with a kind of popular social activity and/or a potential ailment. The communication device can also get and use the data from other areas and provide analysis reports. For example, after a famous event, the people might have habits changes. As a first example, after 2003 SARS (Severe Acute Respiratory Syndrome) event and 2008 Olympic Games, many people in Beijing are going to take more sports activities, which means there are also going to have dishes (food and drink) changing trend. This can be proved by the gym membership increase. As a second example, more people like sweets that would lead to fat shapes. Thus, in a participated future, there may be a high demanding on low calorie foods. If farms are aware of this situation in advance and prepare for planting such agricultural products, there is high chance to get more benefit and incomes.

In an embodiment, the logistical data related to agricultural product may be obtained from at least one of an electronic device installed on a logistical vehicle, an electronic device installed at a road entrance and exit of an agricultural product consumption area, and an electronic device installed along a road. In addition, the logistical data related to agricultural product may be obtained from a logistical firm.

In an embodiment, the logistical data related to agricultural product includes at least one of an identity of agricultural product, a weight of agricultural product, an original place of agricultural product, a destination of agricultural product, and information of a warehouse in which the agricultural product has been stored.

As a first example, the logistical data related to agricultural product may be obtained from the logistical enhancement devices installed on the logistical vehicle such as truck. In smart logistics, each good may have RFID (radio-frequency identification) that shows the content, weight, original places, destination, etc. Each logistical vehicle such as truck may have its routine information. When these information can be shared among licensed users (such as farms), it would bring much convenience for the centralized self-management. For example, each RFID may carry below information:
the content, for example, what agricultural product that this package contains,
the weight of the agricultural product
the original places of the agricultural product, for example, which farm produced this product,
the destination such as target city of the agricultural product,
the warehouse information, for example, which warehouse that this product had been stored, the warehouse starting date, how long time it had been stored. This information can be used for comparing how different warehouse conditions would affect the product quality.

As a second example, the logistical data related to agricultural product may be obtained from the infrastructure in the entrances and exits (such as highway and expressway entrances and exits) of target agricultural product consumption area such as city. For example, the infrastructure may provide quantities of agricultural products that are shipped from agricultural product production areas such as farms to agricultural product consumption areas such as cities via highway and expressway by the logistical vehicle such as truck. For example, by installing a device that can provide below functions in the toll or checkpoints, the device may provide at least one of the following information:
i. How many kinds of agricultural products that shipped in (Assuming it's M₀),
ii. How much wastes of agricultural products that shipped out, and what takes the large percentage (Assuming it's M_{w}, which consists of M_{w1}, M_{w2}, . . . , M_{wx} by w1%, w2%, . . . , wx % separately),
iii. As for a certain agricultural product, how many original places that produced the agricultural product and their percentages (Assuming it's P).

The above information (the logistical data) can bring much beneficial to an agricultural product production area such as farm. For example, is this agricultural product production area the single source for the target agricultural product consumption area such as city? If not, how much percentage of a certain agricultural product from this agricultural product production area. The possibility to optimize the agricultural productions with other agricultural product production areas nearby, including mutual backup mechanism during disaster such as extreme weather periods, warehouse sharing, pest and diseases joint control. The routine from this agricultural product production area to the target agricultural product consumption area, and the analysis of whether there's any space to optimize it by logistical firms. The agricultural product popularity in the target agricultural product consumption area, and in the popularity level comparison among all target agricultural product consumption areas. Waste recycling for natural fertilizer.

As a third example, the logistical data related to agricultural product may be obtained from the sensors equipped by the agricultural product production areas such as farms. For example, along the highway or expressway nearby the agricultural product production areas, the sensor that can identify the truck licenses can enable the agricultural product production areas to know below information:
i. The content, weight, original places, each truck's shipment routine, etc. The farm can use this information to analyze what agricultural products shall be planted for the next season that would make the maximum income.
ii. Also, it established the network among all farms nearby to share information that could optimize like an integral farm.

At block 104, the communication device may generate agricultural activity suggestion for at least one of the plurality of agricultural product production areas based on the agriculture relevant information. The agricultural activity suggestion may include any suitable agricultural activity suggestion such as planting suggestion, risk mitigation suggestion, new markets developments suggestion, suggestion of agricultural production materials, etc. Please note, the term “suggestion” used herein may also comprise “recommendation”.

In an embodiment, the agricultural activity suggestion includes risk mitigation suggestion for a first agricultural product production area. FIG. 2 shows a flowchart of generating risk mitigation suggestion according to an embodiment of the present disclosure. At block 104-2, the communication device may determine a risk factor of disaster for the first agricultural product production area. At block 104-4, the communication device may generate the risk mitigation suggestion for the first agricultural product production area based at least partly on the risk factor of disaster. The disaster may include pest diseases and/or destruction by extreme weathers such as drought, flood, typhoon, etc. For example, the communication device may determine the risk factor of disaster for the first agricultural product production area based on the disaster data (history and/or predicted) of the first agricultural product production area. When the determined risk factor of disaster is larger than a predefined risk value, the communication device may generate the risk mitigation suggestion.

The risk mitigation suggestion may include any suitable suggestion which can avoid or mitigate the disaster, such as suggesting planting an agricultural product which can conquer the disaster such as pest diseases and/or destruction by extreme weathers, suggesting adjusting the cultivation starting time and/or harvest time of agricultural product which can bypass the occurrence time of the disaster, suggesting a cooperative farm to rent a certain amount of land to plant the agricultural production(s), suggesting a warehouse that in the good condition to store agriculture materials as a backup, etc.

In an embodiment, the risk mitigation suggestion for the first agricultural product production area may comprise suggestion for a cooperating agricultural product production area and/or a warehouse.

In an embodiment, the cooperating agricultural product production area may have similar environment with the first agricultural product production area and have a free land to lend. The warehouse can store agriculture materials of the first agricultural product production area.

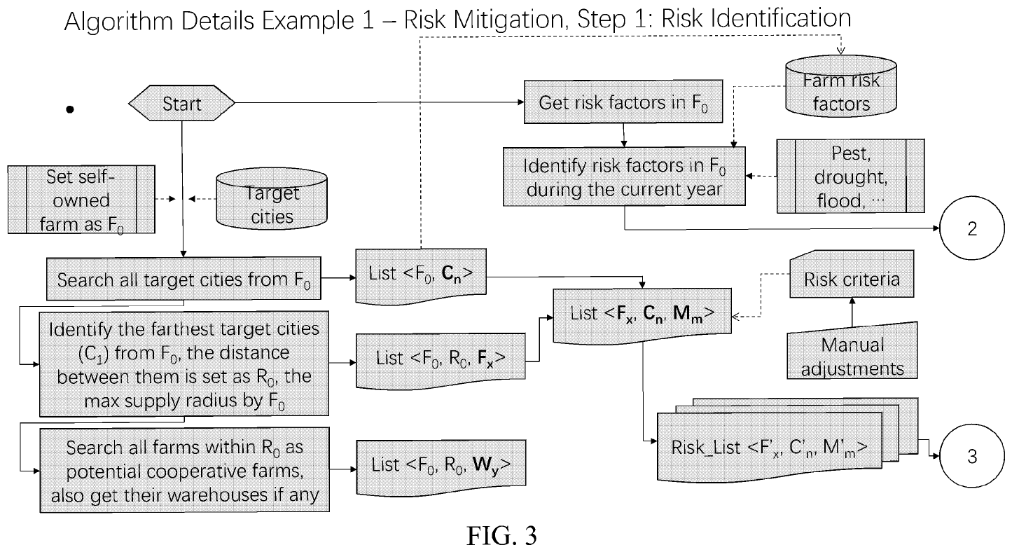

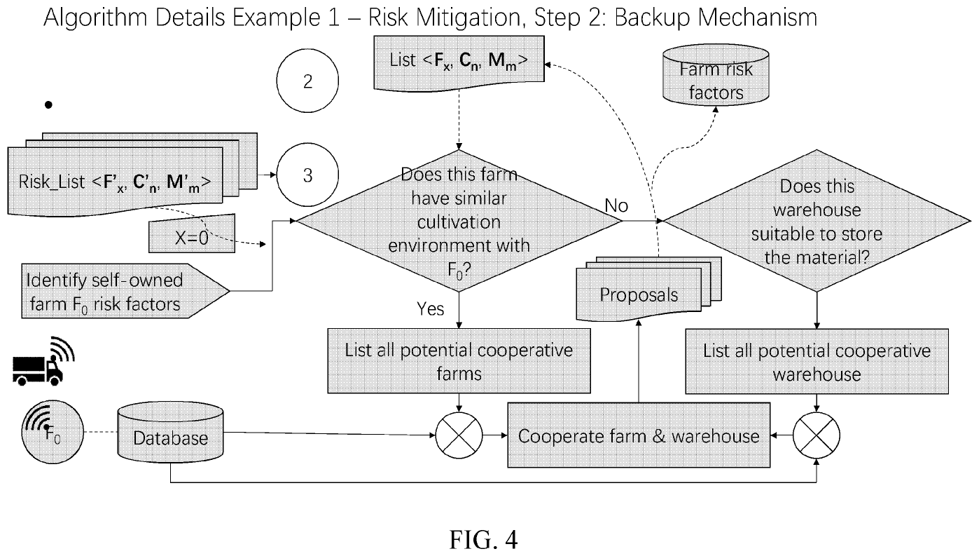

FIG. 3 shows a flowchart of risk identification of algorithm example of risk mitigation according to an embodiment of the present disclosure, which can be performed by the communication device such as server or terminal device. The algorithm of the FIG. 3 illustrates how a farm identify its risk according to the risk criteria list that can be adjusted manually and/or updated iteratively in each cultivation season. The algorithm of the FIG. 3 may store all “target cities” among all farms in a specified region, and then set a farm such as self-owned farm as F₀ to list the target cities of it, the potential cooperative farms and warehouses. The algorithm of the FIG. 3 may set the maximum supply range as R₀ (e.g., the max supply radius of F₀). Then the algorithm of the FIG. 3 may get risk factors of disaster such as pest, drought, flood, typhoon, etc., which will be used in the backup mechanism as shown in FIG. 4. Finally, the algorithm of the FIG. 3 may output a risk factor list by “risk criteria” that can be adjusted manually. The algorithm may identify the “single source” (and/or “large percentage supply” source) issue that might be resulted in:
The income of farm would be heavily impacted if any situation caused disasters.
The price of agricultural product material would be increased significantly as there's no backup source/plan.

FIG. 4 shows a flowchart of backup mechanism of algorithm example of risk mitigation according to an embodiment of the present disclosure, which can be performed by the communication device such as server or terminal device. The algorithm of the FIG. 4 illustrates how these risk factors may be mitigated and furthermore, how these farms can become cooperative to setup a mutual backup mechanism and work together to reach a better economic plan. The entire process of agricultural production may have following factors: farm, logistics and warehouse. This diagram of FIG. 4 illustrates how they can cooperative in a better way: If any farm is at risk of the disasters on whether, pest or any other force majeure, then it will seek at least one cooperative farm to rent a certain amount of land to plant the agricultural production(s). The requirement is the potential cooperative farm has similar environment with the farm and has the free land to lend. If it is impossible to rent lands for this potential cooperative farm, then the farm will continue to seek whether there's any warehouse which is in the good condition to store agriculture materials as a backup.
The cooperative farm and/or the warehouse may be on the routine between the farm (F₀) and the target city to minimize the logistical cost. The sensors equipped along the highway or expressway nearby the farm can monitor the logistical vehicles (such as trucks) nearby and collect the expected information. As aforementioned, it can compare the logistical data with the data from the toll of a target city, then output a feasible plan of where the backup farm and/or warehouse shall be located.

Finally, the algorithm of the FIG. 4 may update the farm risk factors database and the farm risk factors data can be referred in the next iteration.

In an embodiment, the agricultural activity suggestion includes new markets development suggestion for a second agricultural product production area.

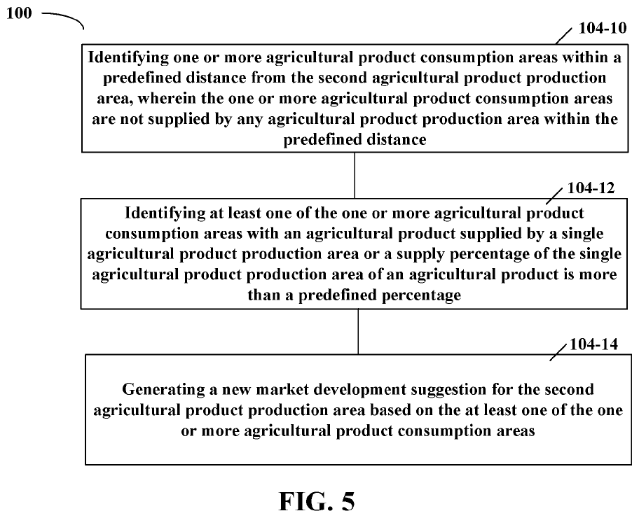

FIG. 5 shows a flowchart of generating new markets development suggestion according to an embodiment of the present disclosure, which can be performed by the communication device such as server or terminal device.

At block 104-10, the communication device may identify one or more agricultural product consumption areas within a predefined distance from the second agricultural product production area. The one or more agricultural product consumption areas are not supplied by any agricultural product production area within the predefined distance at block.

At block 104-12, the communication device may identify at least one of the one or more agricultural product consumption areas with an agricultural product supplied by a single agricultural product production area or a supply percentage of the single agricultural product production area of an agricultural product is more than a predefined percentage.

At block 104-14, the communication device may generate a new markets development suggestion for the second agricultural product production area based on the at least one of the one or more agricultural product consumption areas.

In an embodiment, the new markets development suggestion for the second agricultural product production area may comprise at least one of indicating the second agricultural product production area to select a potential target agricultural product consumption area on a routine between the second agricultural product production area and an existing agricultural product consumption area supplied by the second agricultural product production area; and indicating the second agricultural product production area to select a potential target agricultural product consumption area within a predefined distance in an extended line of an existing routine between the second agricultural product production area and an existing agricultural product consumption area supplied by the second agricultural product production area.

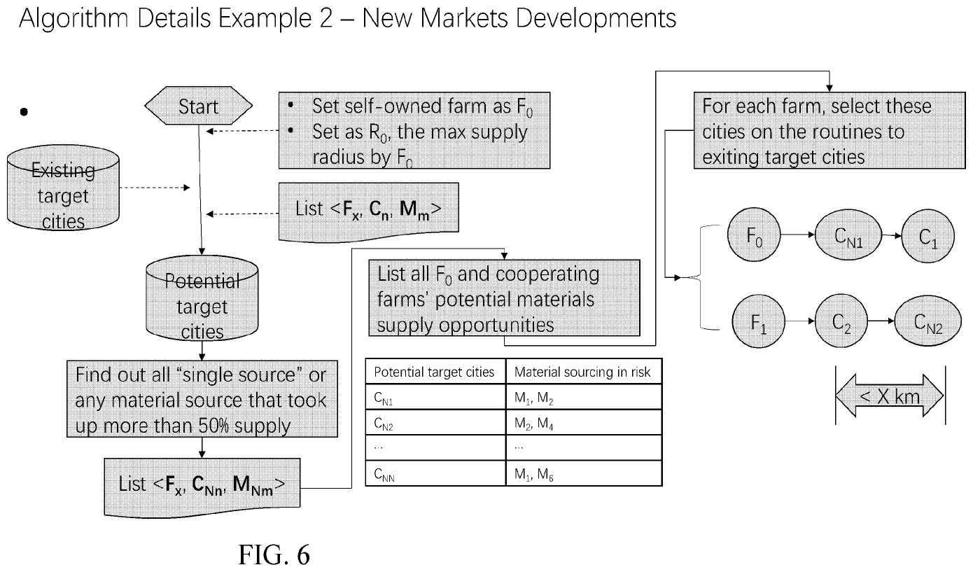

FIG. 6 shows a flowchart of algorithm example of generating new markets development suggestion according to another embodiment of the present disclosure, which can be performed by the communication device such as server or terminal device. The algorithm of FIG. 6 illustrates how a farm (such as farm F₀) develops new markets more efficiency. The algorithm of FIG. 6 may search out all cities within R₀ (the max supply radius of F₀) that are not in any farms' supply in the same range (R₀) as “potential target cities”. Then the algorithm of FIG. 6 may identify at least one single sources and/or at least one agricultural product material source that takes up more than a predefined percentage (such as 50%) supply. The criterion can be customized according to a specified potential target city. According to the criteria, the algorithm of FIG. 6 may output a table for new markets development and the farm may select at least one city on the routines to existing target cities. For example, the best choice may be the potential target city on the routine from the farm to an existing city. The alternative is to select a city within a predefined distance in the extended line of the existing routine.

In an embodiment, the agricultural activity suggestion includes suggestion of agricultural production materials for a third agricultural product production area.

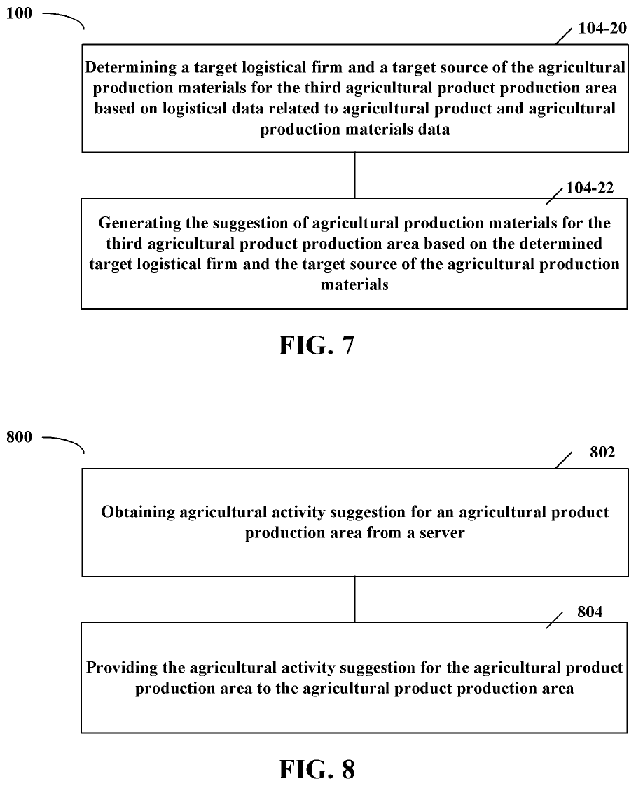

FIG. 7 shows a flowchart of generating the suggestion of agricultural production materials according to an embodiment of the present disclosure, which can be performed by the communication device such as server or terminal device.

At block 104-20, the communication device may determine a target logistical firm and a target source of the agricultural production materials for the third agricultural product production area based on logistical data related to agricultural product and agricultural production materials data. For example, the communication device may identify at least one potential target source of the agricultural production materials and at least one potential target logistical firm and then can determine the target logistical firm and the target source of the agricultural production materials for the third agricultural product production area to minimize the cost, such as total cost or logistical cost or the agricultural production materials cost, etc. For example, when logistical trucks return from cities, they can also carry the specified garbage which can be used as fertilizer to certain farms.

At block 104-22, the communication device may generate the suggestion of agricultural production materials for the third agricultural product production area based on the determined target logistical firm and the target source of the agricultural production materials.

In an embodiment, the agricultural activity suggestion includes planting suggestion for a fourth agricultural product production area. For example, the communication device may generate planting suggestion for an agricultural product production area based on at least one of the soil data of an agricultural product production area, climate data of an agricultural product production area, disaster data of an agricultural product production area, statistical data of agricultural product consumption in an agricultural product consumption area, trend analysis of agricultural product consumption in an agricultural product consumption area, warehouse condition and availability and logistical data related to agricultural product. If the soil data indicates that the soil is suitable for planting a specific type of agricultural product, then the specific type of agricultural product may be recommended. If the climate data indicates that the climate is suitable for planting a specific type of agricultural product, then the specific type of agricultural product may be recommended. If the disaster data indicates that a specific pest disease may be prone to happen in an agricultural product production area, then the agricultural product that can conquer the pest disease may be recommended. If the disaster data indicates that the destruction caused by extreme weather may be prone to happen in an agricultural product production area, then the agricultural product that can conquer the extreme weather may be recommended. If the statistical data indicates that an agricultural product is the most popular in an agricultural product production area, then the agricultural product may be recommended. If the trend analysis indicates that an agricultural product will be the most popular in an agricultural product production area, then the agricultural product may be recommended. If the warehouse condition and availability indicates that an agricultural product is suitable for storing in a warehouse for example in order to conquer the pest diseases and/or avoid destruction by extreme weathers and/or reduce warehouse cost, then the agricultural product may be recommended. If the logistical data related to agricultural product indicates that an agricultural product production area is the single source or takes a large percentage of an agricultural product for a target agricultural product consumption area, then the agricultural product may be recommended. When an agricultural product is suggested or recommended, the cultivation starting time, harvest time, etc. may also be suggested or recommended.

With reference to FIG. 1, at block 106, the communication device may send the agricultural activity suggestion to the at least one of the plurality of agricultural product production areas. For example, the communication device may send the agricultural activity suggestion for an agricultural product production area to the agricultural product production area when the agricultural product production area requests the agricultural activity suggestion from the communication device. Alternatively, the communication device may send the agricultural activity suggestion for an agricultural product production area to the agricultural product production area when the agricultural activity suggestion for the agricultural product production area is generated. In addition, the agricultural activity suggestion may include other information such as agricultural activity recommendation.

FIG. 8 shows a flowchart of a method 800 according to another embodiment of the present disclosure, which may be performed by an apparatus implemented in or as or communicatively coupled to a terminal device or any other entity having similar functionality. As such, the terminal device may provide means or module for accomplishing various parts of the method 800 as well as means for accomplishing other processes in conjunction with other components. For some parts which have been described in the above embodiments, detailed description thereof is omitted here for brevity.

At block 802, the terminal device may obtain agricultural activity suggestion for an agricultural product production area from a server. The agricultural activity suggestion for the agricultural product production area may be generated based on agriculture relevant information as described above. For example, the communication device such as server may send the agricultural activity suggestion for an agricultural product production area to the agricultural product production area as shown in bock 106 of FIG. 1, and then the terminal device may obtain the agricultural activity suggestion. For example, the owner of the agricultural product production area may obtain the agricultural activity suggestion by using web browser or application installed in the terminal device.

At block 804, the terminal device may provide the agricultural activity suggestion for the agricultural product production area to the agricultural product production area. For example, the terminal device may provide the agricultural activity suggestion through web browser or application installed in the terminal device to the owner of the agricultural product production area.

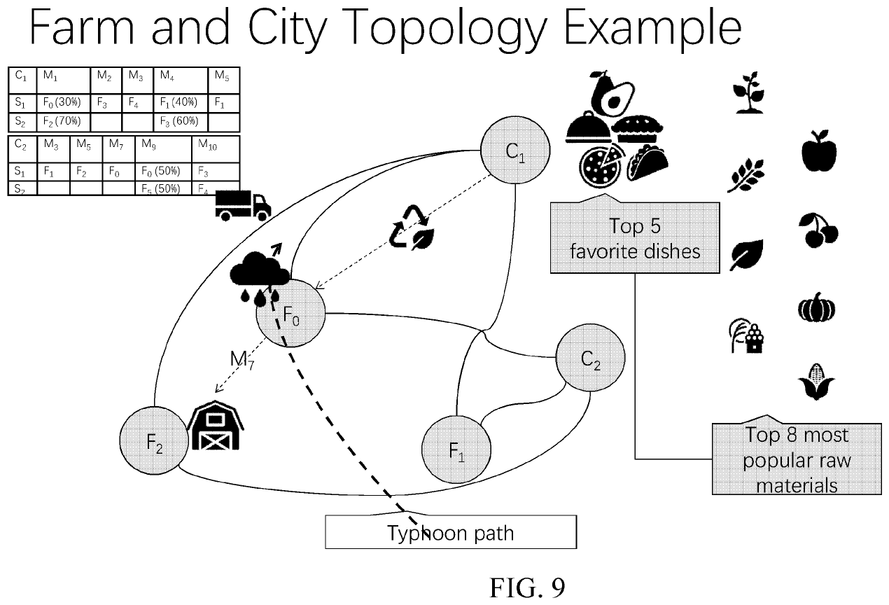

FIG. 9 schematically shows a topology of farm and city according to an embodiment of the present disclosure. In an embodiment, the communication device may obtain the agriculture relevant information from a farm (F₀) and all farms nearby (F₁, F₂, . . . Fₓ) as well as all target cities (C₁, C₂, . . . Cₙ). The communication device may obtain the top favorite dishes (N₁, N₂, . . . Nₙ) from all target cities (C₁, C₂, . . . Cₙ), and all raw materials (M₁, M₂, . . . , Mₘ) of these dishes. Then the communication device may select the most common popular of M agricultural raw materials. With above data series, below tables 1-2 can be formulated.

Assuming that there are three farms: F₀ (self-owned), F₁ and F₂ (F₃, F₄ and F₅ are not shown in FIG. 9), two cities: C₁ and C₂, several highway or expressway between them. Assuming that each city has five popular raw materials as analysis from N most favorite dishes, and each raw material has one or two sourcing farms.

TABLE 1
the sourcing farms of raw materials and their percentages

| C₁ | M₁ | M₂ | M₃ | M₄ | M₅ |
|---|---|---|---|---|---|
| S₁ | F₀ (30%) | F₃ | F₄ | F₁ (40%) | F₁ |
| S₂ | F₂ (70%) | | | F₃ (60%) | |

TABLE 2
the sourcing farms of raw materials and their percentages

| C₂ | M₃ | M₅ | M₇ | M₉ | M₁₀ |
|---|---|---|---|---|---|
| S₁ | F₁ | F₂ | F₀ | F₀ (50%) | F₃ |
| S₂ | | | | F₅ (50%) | F₄ |

The weight of all raw materials may be collected and calculated as well. For example, in above statistical tables 1-2, F₀ provides to C₁ with M₁ by 30% and the weight is 3 tons. F₀ provides to C₂ with M₇ by 100% and the weight is 20 tons. F₀ provides to C₂ with M₉ by 50% and the weight is 5 tons.

Apparently, F₀ is the single source of M₇ for C₂ while F₀ is also taking a large percentage of M₇ for C₂. M₇ and M₅ may be the stable income for F₀. However, as the weather historical data and forecast indicates that F₀ is always in the path of typhoon, this would be a major risk factor for both F₀ and C₂. As a mitigation plan, F₀ can setup a backup mechanism with F₁ and/or F₂ nearby. For example, when trucks returns from C₁, they can take away a quantity of M₇ from F₀ to store at F₂. F₀ can rent a certain area of F₁'s land to plan M₇, as F₁ also has business with C₂.

As a supplement feature, when trucks return from cities, they can also carry the specified garbage which can be used as fertilizer to certain farms. How the garbage processed can use the same algorithm of process agricultural materials in reverse direction.

This proposed solution may provide various agricultural activity suggestion for owners of agricultural product production areas. The owners of agricultural product production areas may discuss and then work out a feasible plan which is benefit to them all. When they reach the agreement, the corresponding agricultural product consumption areas may also be notified. The proposed method may be done iteratively to identify the most optimized way. The proposed method is also applicable when there are more agricultural product production areas and agricultural product consumption areas. In this way, agricultural product production areas can balance the productivity for different agricultural products, establish the mutual backup mechanism. The logistical firms can also optimize the routine. The agricultural product consumption areas can mitigate the risk of single source problem to prevent inflation when disaster (such as typhoon) happened in their sourcing farms.

Embodiments herein afford many advantages, of which a non-exhaustive list of examples follows. Some embodiments herein can centralize all agricultural product production areas (such as farms) in a geographic area to optimize all kinds of information asymmetric and communication overhead, save cost for warehouse and logistic, reduce waste, and increase the satisfaction for consumers and the income for producers such as farmers. Some embodiments herein can self-organize all farms in an area to work more tightly with exchanging information and then optimize the cultivation. Some embodiments herein can connects the farm, warehouse, logistics firm, supermarket and the end consumers before the agricultural cultivation and reduce the relevant fees in each steps of the entire agricultural product production process and even the advertisement fee for products. Some embodiments herein can enable the farm to have a clear plan of what and how to calculate the agricultural products. Some embodiments herein can enable farms nearby to establish the backup mechanisms to conquer the disaster such as the pest diseases, destruction by extreme weathers, etc. Some embodiments herein can enable the warehouse to be more effectively utilized. Some embodiments herein can enable the logistics routine to be optimized (e.g., save leading time to downtown and energies by trucks). Some embodiments herein can enable the end consumer to enjoy a better shopping environment with more favorite products. For example, they can even visit the original farm to see how these products are cultivated, which is another way to increase the income for the farm. Some embodiments herein can enable the root cause to be easily found when any situation is happened. In some embodiments herein, the budget of the farm can be easily controlled while the income can be forecasted, which is a good way to plan for the farm. Some embodiments herein can improve the entire agricultural production line from the farm to the dining table and encourage the owner of farms to cooperative together in a more graceful way. In some embodiments herein, the proposed method may be suitable in a large area where farms are located in vast of lands as well as their target cities are always far away. In some embodiments herein, the proposed method may centralize the information in all relevant areas, such as land, climate, warehouse, logistics, favorite dishes (raw materials), waste recycling, etc. In this way, the overhead of all interconnecting steps and communication could be significantly reduced. In some embodiments herein, the proposed method may mitigate the risk for both farms and target cities, for example, any disaster would result in the great damage to farms and the inflation to target cities. The embodiments herein are not limited to the features and advantages mentioned above. A person skilled in the art will recognize additional features and advantages upon reading the following detailed description.

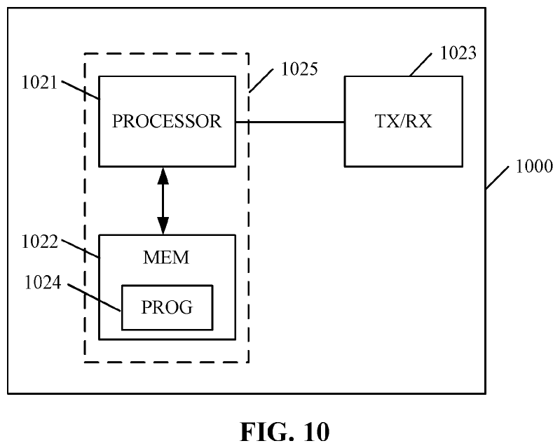

FIG. 10 is a block diagram showing an apparatus suitable for practicing some embodiments of the disclosure. For example, any one of the communication device, the terminal device described above may be implemented as or through the apparatus 1000.

The apparatus 1000 comprises at least one processor 1021, such as a DP, and at least one MEM 1022 coupled to the processor 1021. The apparatus 1020 may further comprise a transmitter TX and receiver RX 1023 coupled to the processor 1021. The MEM 1022 stores a PROG 1024. The PROG 1024 may include instructions that, when executed on the associated processor 1021, enable the apparatus 1020 to operate in accordance with the embodiments of the present disclosure. A combination of the at least one processor 1021 and the at least one MEM 1022 may form processing means 1025 adapted to implement various embodiments of the present disclosure.

Various embodiments of the present disclosure may be implemented by computer program executable by one or more of the processor 1021, software, firmware, hardware or in a combination thereof.

The MEM 1022 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1021 may be of any type suitable to the local technical environment, and may include one or more of general purpose computers, special purpose computers, microprocessors, digital signal processors DSPs and processors based on multicore processor architecture, as non-limiting examples.

In an embodiment where the apparatus is implemented as or at the communication device, the memory 1022 contains instructions executable by the processor 1021, whereby the communication device operates according to the method as described in reference to FIG. 1.

In an embodiment where the apparatus is implemented as or at the terminal device, the memory 1022 contains instructions executable by the processor 1021, whereby the terminal device operates according to the method 800 as described in reference to FIG. 8.

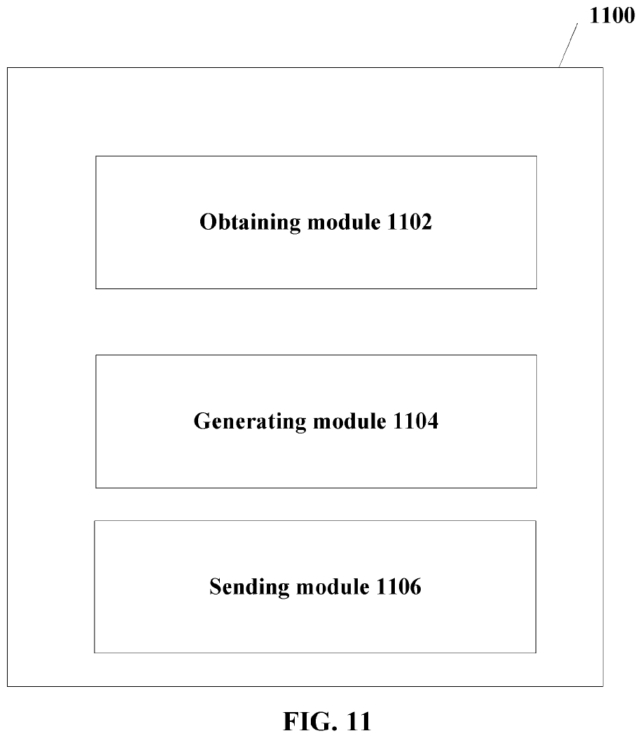

FIG. 11 is a block diagram showing a communication device according to an embodiment of the disclosure. As shown, the communication device 1100 comprises an obtaining module 1102, a generating module 1104 and a sending module 1106. The obtaining module 1102 may be configured to obtain agriculture relevant information in a geographic area including a plurality of agricultural product production areas. The generating module 1104 may be configured to generate agricultural activity suggestion for at least one of the plurality of agricultural product production areas based on the agriculture relevant information. The sending module 1106 may be configured to send the agricultural activity suggestion to the at least one of the plurality of agricultural product production areas.

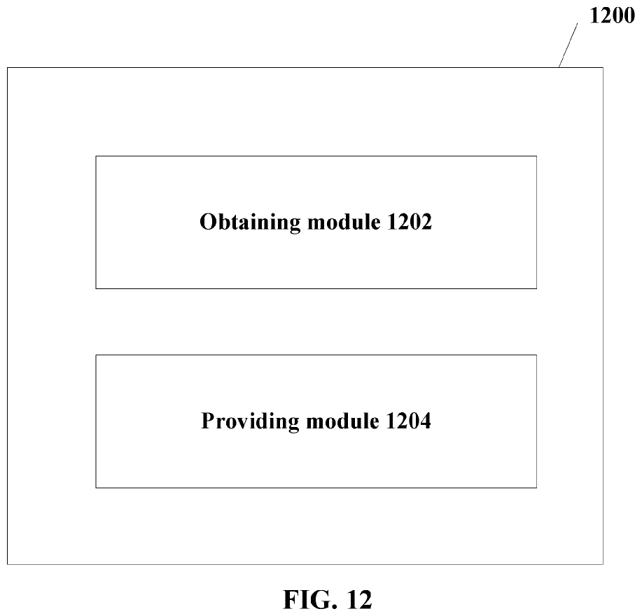

FIG. 12 is a block diagram showing a terminal device according to an embodiment of the disclosure. As shown, the terminal device 1200 comprises an obtaining module 1202 and a providing module 1204. The obtaining module 1202 may be configured to obtain agricultural activity suggestion for an agricultural product production area from a server. The agricultural activity suggestion for the agricultural product production area may be generated based on agriculture relevant information The providing module 1204 may be configured to provide the agricultural activity suggestion for the agricultural product production area to the agricultural product production area.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-31. (canceled)

32. A method performed by a communication device, comprising:
obtaining agriculture relevant information in a geographic area including a plurality of agricultural product production areas;
generating agricultural activity suggestion for at least one of the plurality of agricultural product production areas based on the agriculture relevant information; and
sending, via a communication network, the agricultural activity suggestion to the at least one of the plurality of agricultural product production areas.

33. The method according to claim 32, wherein the agriculture relevant information includes at least one of the following:
soil data of an agricultural product production area,
climate data of an agricultural product production area,
agricultural production materials data,
disaster data of an agricultural product production area,
statistical data of agricultural product consumption in an agricultural product consumption area,
trend analysis of agricultural product consumption in an agricultural product consumption area,
warehouse condition and availability, and
logistical data related to agricultural product.

34. The method according to claim 33, wherein the logistical data related to agricultural product is obtained by the communication device from at least one of the following:
an electronic device installed on a logistical vehicle,
an electronic device installed at a road entrance and exit of an agricultural product consumption area, and
an electronic device installed along a road.

35. The method according to claim 33, wherein the logistical data related to agricultural product includes at least one of the following:
an identity of agricultural product,
a weight of agricultural product,
an original place of agricultural product,
a destination of agricultural product, and
information of a warehouse in which the agricultural product has been stored.

36. The method according to claim 32, wherein the agricultural activity suggestion includes risk mitigation suggestion for a first agricultural product production area, and generating agricultural activity suggestion comprises:
determining a risk factor of disaster for the first agricultural product production area; and
generating the risk mitigation suggestion for the first agricultural product production area based at least partly on the risk factor of disaster.

37. The method according to claim 36, wherein the risk mitigation suggestion for the first agricultural product production area comprises suggestion for a cooperating agricultural product production area and/or for a warehouse.

38. The method according to claim 37, wherein generating the risk mitigation suggestion is based on one or more of the following:
the cooperating agricultural product production area having a similar environment as the first agricultural product production area and having available land, and
the warehouse being available for storing agriculture materials of the first agricultural product production area.

39. The method according to claim 37, wherein generating the risk mitigation suggestion is further based on the cooperating agricultural product production area and/or the warehouse being on a route between the first agricultural product production area and a target agricultural product consumption area.

40. The method according to claim 32, wherein the agricultural activity suggestion includes new markets development suggestion for a second agricultural product production area and generating the agricultural activity suggestion comprises:
identifying one or more agricultural product consumption areas that are within a predefined distance from the second agricultural product production area and that are not supplied by any agricultural product production area within the predefined distance;
selecting at least one of the identified agricultural product consumption areas that meets one of the following conditions: an agricultural product supplied by a single agricultural product production area, or a supply percentage of the single agricultural product production area of an agricultural product is more than a predefined percentage; and
generating a new market development suggestion for the second agricultural product production area based on the selected at least one agricultural product consumption area.

41. The method according to claim 40, wherein the new market development suggestion for the second agricultural product production area comprises at least one of the following:
a potential target agricultural product consumption area on a route between the second agricultural product production area and an existing agricultural product consumption area supplied by the second agricultural product production area; and
a potential target agricultural product consumption area within a predefined distance in an extended line of an existing route between the second agricultural product production area and an existing agricultural product consumption area supplied by the second agricultural product production area.

42. The method according to claim 32, wherein the agricultural activity suggestion includes suggestion of agricultural production materials for a third agricultural product production area and generating the agricultural activity suggestion comprises:
determining a target logistical firm and a target source for the agricultural production materials for the third agricultural product production area, based on logistical data related to agricultural product and on agricultural production materials data; and
generating the suggestion of agricultural production materials for the third agricultural product production area based on the determined target logistical firm and the determined target source of the agricultural production materials.

43. The method according to claim 32, wherein the agricultural activity suggestion includes planting suggestion for a fourth agricultural product production area.

44. The method according to claim 32, wherein the communication device is a server or a terminal device.

45. A method performed by a terminal device, the method comprising:
obtaining agricultural activity suggestion for an agricultural product production area from a server via a communication network; and
providing the agricultural activity suggestion for the agricultural product production area to the agricultural product production area,
wherein the agricultural activity suggestion for the agricultural product production area is based on agriculture relevant information.

46. The method according to claim 45, wherein the agriculture relevant information includes at least one of the following:
soil data of an agricultural product production area,
climate data of an agricultural product production area,
agricultural production materials data,
disaster data of an agricultural product production area,
statistical data of agricultural product consumption in an agricultural product consumption area,
trend analysis of agricultural product consumption in an agricultural product consumption area,
warehouse condition and availability, and
logistical data related to agricultural product.

47. The method according to claim 46, wherein the logistical data related to agricultural product is obtained from at least one of the following:
an electronic device installed on a logistical vehicle,
an electronic device installed at a road entrance and exit of an agricultural product consumption area, and
an electronic device installed along a road.

48. The method according to claim 46, wherein the logistical data related to agricultural product includes at least one of the following:
an identity of agricultural product,
a weight of agricultural product,
an original place of agricultural product,
a destination of agricultural product, and
information of a warehouse in which the agricultural product has been stored.

49. The method according to claim 46, wherein the agricultural activity suggestion includes one or more of the following:
risk mitigation suggestion for the agricultural product production area,
new markets development suggestion for the product production area,
suggestion of agricultural production materials for the agricultural product production area, and
planting suggestion for the agricultural product production area

50. The method according to claim 49, wherein one or more of the following applies:
the risk mitigation suggestion for the agricultural product production area comprises suggestion for a cooperating agricultural product production area and/or for a warehouse; and
the new markets development suggestion includes one of the following:
a potential target agricultural product consumption area on a route between the agricultural product production area and an existing agricultural product consumption area supplied by the agricultural product production area; or
a potential target agricultural product consumption area within a predefined distance in an extended line of an existing route between the agricultural product production area and an existing agricultural product consumption area supplied by the agricultural product production area.

51. A communication device, comprising:
a transmitter;
a processor operably coupled to the transmitter; and
a memory operably coupled to the processor and containing instructions executable by said processor, whereby said communication device is operative to:
obtain agriculture relevant information in a geographic area including a plurality of agricultural product production areas;
generate agricultural activity suggestion for at least one of the plurality of agricultural product production areas based on the agriculture relevant information; and
using the transmitter, send the agricultural activity suggestion to the at least one of the plurality of agricultural product production areas via a communication network.
